(19) United States
(12) Patent Application Publication
(10) Pub. No.: US 2006/0231778 A1
(43) Pub. Date: Oct. 19, 2006

(54) Machine vision based scanner using line scan camera

(75) Inventors: Sudha Umesh Kumar, Carlsbad, CA (US); Kexiang Ken Ding, San Diego, CA (US); Brian Avery, San Dimas, CA (US); Kenneth B. Uekert, Ramona, CA (US); Samer Kabbani, Carlsbad, CA (US)

Correspondence Address: FOLEY AND LARDNER LLP;SUITE 500, 3000 K STREET NW, WASHINGTON, DC, 20007, US

(73) Assignee: Delta Design, Inc.

(21) Appl. No.: 11/392,997

(22) Filed: Mar. 30, 2006

Related U.S. Application Data
(60) Provisional application No. 60/666,199, filed on Mar. 30, 2005.

(51) Int. Cl. G01N 21/86; G01V 8/00

(52) U.S. Cl. 250/559.4

(57) ABSTRACT

A machine vision based scanner system for an offline binning handler including a line scan camera capable of scanning a full tray-width image of a media tray, a camera controller operatively connected to the line scan camera, a tray transport mechanism positioned below the line scan camera, a tray transport mechanism controller operatively connected to the tray transport mechanism and the camera controller and processing software for using the images captured by the line scan camera to identify and sort a plurality of devices.

### CROSS-REFERENCE TO RELATED PATENT APPLICATIONS

This instant application claims priority to and benefit of U.S. Provisional Application 60/666,199 filed Mar. 30, 2005 the disclosure of which is incorporated by reference herein in its entirety.

### FIELD OF INVENTION

The present invention relates generally to a machine vision based scanner using a line scan camera, and more particularly to a machine vision based scanner for scanning markings on a semiconductor device on a carrier transport medium.

### BACKGROUND OF THE INVENTION

Semiconductor devices are commonly sorted into different categories based on performance characteristics determined during test by specialized processing equipment. Transport media include any fixture or carrier designed for transporting semiconductor devices internal or external to the processing equipment. An example is a plastic tray as specified by the JEDEC Design Standard. In most cases, the processing equipment has a vision system and a lighting system to aid in identifying and sorting the devices.

In the “back-end” of semiconductor manufacturing, a conventional binning machine may have multiple area scan cameras. Generally, two or more cameras are used to decode two dimensional matrices on semiconductor devices located on a tray such as a plastic tray as specified by the JEDEC Design Standard (referred to as a JEDEC tray). Semiconductor devices are commonly sorted into different categories based on performance characteristics determined during test. Each camera scans a section of the JEDEC tray. The images captured by each camera are then restructured so that a complete image of the JEDEC tray is obtained. Because multiple cameras are used to scan portions of the tray, several disadvantages may arise.

For example, there may be difficulty in processing and analyzing overlapping images. In order for complete image capture, the JEDEC tray must remain stationary underneath the cameras, resulting in a reduction of the number of devices processed per hour. If the scanning area changes due the processing of a JEDEC tray having devices packages of a different size, the overlapping fields of view between cameras must be adjusted by changing lenses and/or the focal length of the cameras. Such changes require a physical change in hardware. Further, the system is limited to only being able to accomplish two dimensional matrix reading leaving other time consuming “back-end” processes such as inspection for another system or operator.

Therefore, a cost-effective and device package independent scanner is needed that will allow two dimensional data code matrix reading and aid in the inspection of devices positioned on a JEDEC tray without impacting the number of devices processed per hour.

### SUMMARY OF THE INVENTION

According to one embodiment of the present invention, a machine vision based scanner system for an offline binning handler comprises a line scan camera capable of scanning a full tray-width image of a media tray, a camera controller operatively connected to the line scan camera, a tray transport mechanism positioned below the line scan camera, a tray transport mechanism controller operatively connected to the tray transport mechanism and the camera controller, and processing software for using images captured by the line scan camera to identify and sort a plurality of devices.

According to another embodiment of the invention, the line scan camera is a 8 K pixel line scan camera having a depth of field of 4.0 mm.

According to yet another embodiment of the present invention, the processing software generates a recipe file for each package and tray type scanned by the line scan camera, whereby the recipe file contains information regarding regions of interest.

According to still another embodiment of the present invention, the tray transport mechanism is configured to carry a plurality of JEDEC trays in and out of the offline binning handler.

### BRIEF DESCRIPTION OF THE DRAWINGS

FIG. 1 is a perspective view of the line scan camera incorporated into a binning handler apparatus.

FIG. 2 is a top view of a JEDEC tray as seen through the line scan camera of the present invention.

FIG. 3 is a top view of a JEDEC tray as seen through the line scan camera of the present invention.

FIG. 4 is a block diagram of a machine vision based scanner system according to one embodiment of the invention.

### DETAILED DESCRIPTION OF THE PREFERRED EMBODIMENTS

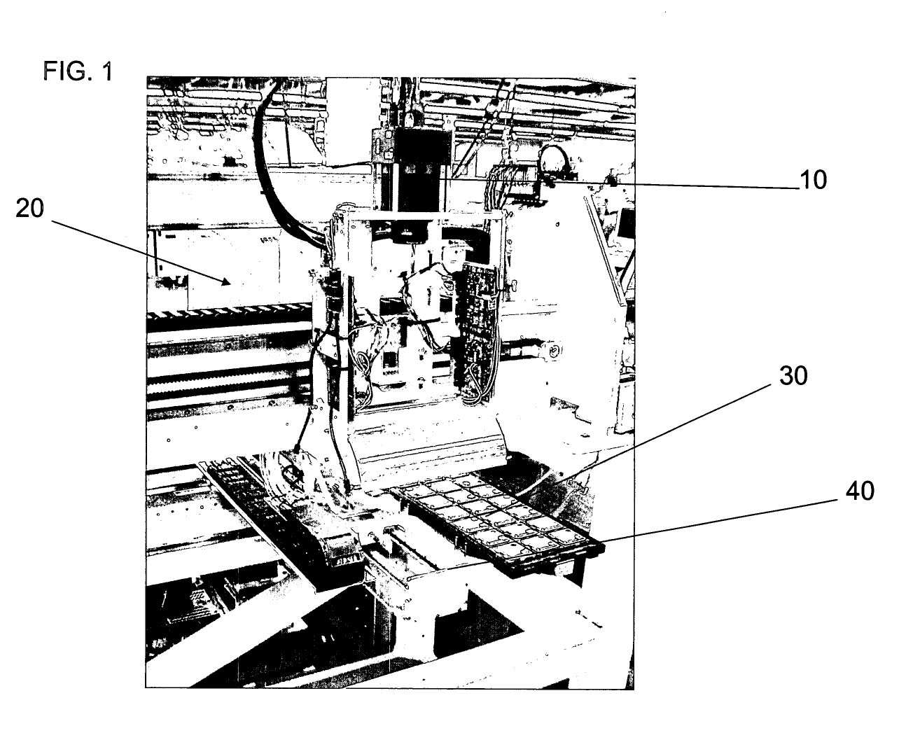

An exemplary vision based scanner system according to the present invention is now described in reference to the accompanying drawings. It will be appreciated that the vision based scanner system according to the invention may be used advantageously with a backend IC automated handling machine (as shown in FIG. 1) that sorts devices, such as semiconductor devices, into categories based on a unique identification code on each device. In turn, each code is associated with a category number. The automated handling equipment uses a vision system incorporating the line scan camera to identify each device. The system keeps track of the device location inside each tray and sorts them into trays, particularly JEDEC trays, such that devices of the same category are in the same tray. Of course other applications may be apparent to those skilled in the art.

According to one embodiment of the invention, a binning handler 20 incorporating a line scan camera 10 is shown in FIG. 1. The line scan camera 10 is mounted to the binning handler 20 as shown in FIG. 1. As described in more detail below, a camera controller 50 is operatively connected to the line scan camera 10. The camera controller 50 may be connected to the line scan camera by any one of a number of known methods including a cable or wire. In addition, the line scan camera is operatively connected to an image processor 70 running image processing software. As further shown in FIG. 1, a tray transport mechanism 40 is operatively connected to the binning handler 20 and is positioned below the line scan camera 10. A transport mechanism controller 60 is operatively connected to the transport mechanism 40 and to the camera controller 50.

The line scan camera 10 of the present invention preferably has a resolution of anywhere from 8 k-12 k. More preferably, the line scan camera 10 has a resolution of about 8 k and a depth of field of 4.0 mm. In addition, according to another embodiment of the present invention, the depth of field of the scan line camera 10 can be enhanced so that device packages of varying thickness positioned in the same JEDEC tray 30 can be inspected. The line scan camera 10 is mounted in a fixed position and is capable of scanning an entire JEDEC tray 30 as the tray 30 passes underneath the line scan camera 10 on a tray transport mechanism 30. The line scan camera 30 is also capable of scanning trays 30 moving on the transport mechanism in both the forward (into the handler) and reverse (out of the handler) direction.

Referring to FIG. 1, the tray transport mechanism 40 is capable of carrying a JEDEC tray 30 in and out of the binning handler 20. The transport mechanism 40 moves at a constant velocity. The line scan camera 10 is used to capture images of JEDEC trays 30 going in and out of the system, allowing for closed loop binning.

Briefly, closed loop binning is a process for sorting semiconductor devices where a JEDEC tray 30 input into the system is first scanned. The devices in the JEDEC tray 30 are sorted and placed in output trays. As the output trays exit the system they are scanned again. This second scan is to inspect the output tray and confirm that the devices were categorized correctly.

The line scan camera 10 can scan JEDEC trays 30 traveling on the tray transport mechanism 40 in the forward or reverse direction. Preferably, the JEDEC trays 30 pass beneath the line scan camera 10 at an elevation that puts the top surface of the device packages residing in the tray 30 at the camera focal plane.

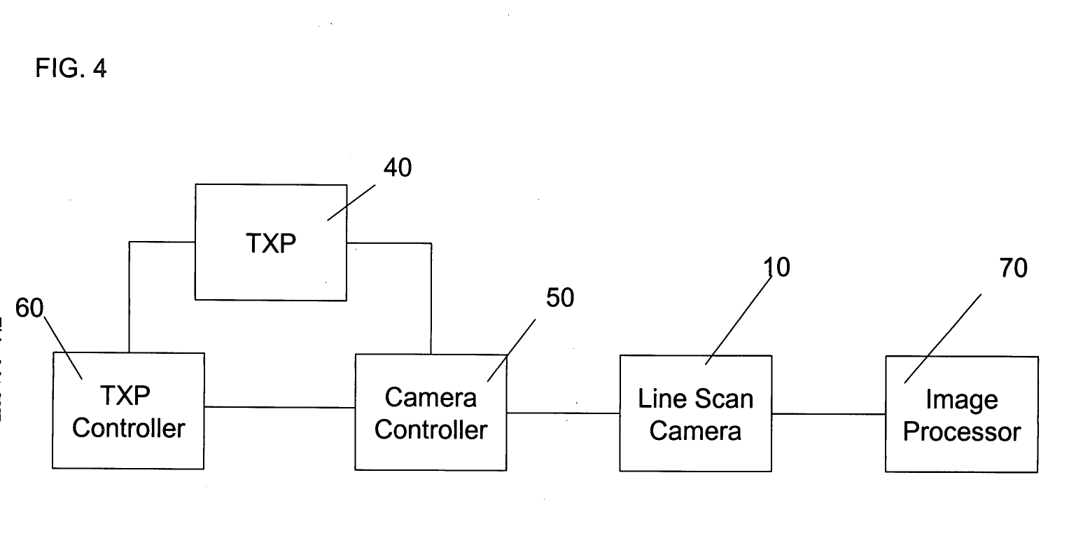

Referring to FIG. 4, during operation of the binning handler, the transport mechanism controller 60 provides a start signal to the line scan camera controller 50, which in turn enables the line scan camera 10. The line scan camera controller 50 operates such that the camera scanning speed matches that of the transport mechanism 40 velocity. In order to achieve this, a Y-axis encoder signal from the transport mechanism 40 is input to the camera controller 50. The camera controller 50 divides this as a function of the field of view to allow the line scan camera 10 speed to match the tray velocity.

The embodiment of the present invention shown captures and creates a full tray-width image of a JEDEC tray 30 using the line scan camera 10. The image captured is an image of an entire JEDEC tray 30. The image is captured as JEDEC trays 30 pass underneath the line scan camera 10 via the tray transport mechanism 40 resulting in no impact to the number of units processed per hour. If the line scan camera controller 50 detects that scanning of a JEDEC tray 30 failed the JEDEC tray 30 is rescanned.

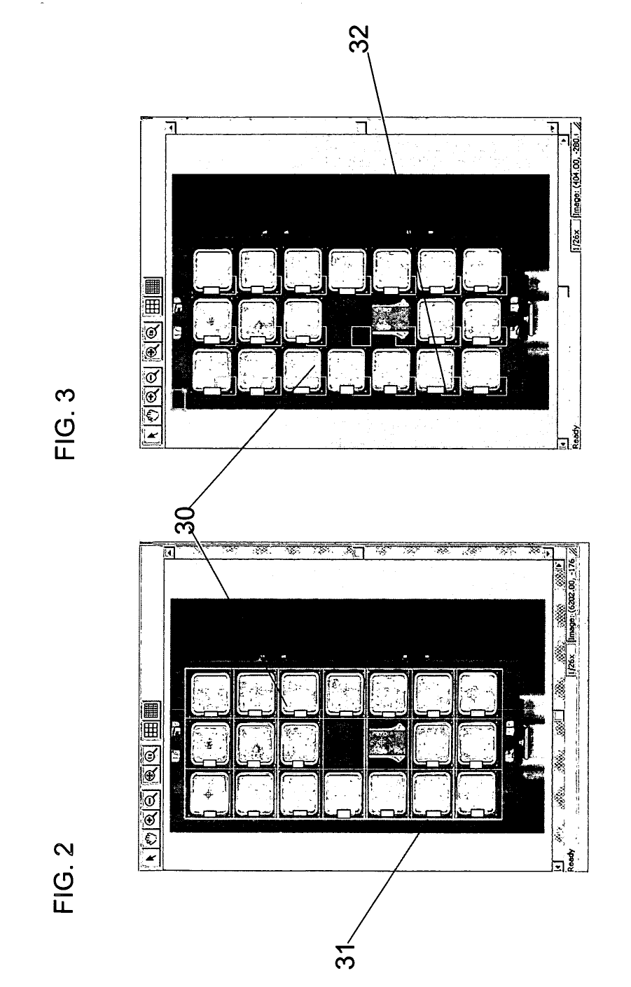

As each JEDEC tray 30 is scanned by the line scan camera 10, an image is generated and the system's image processor 70 generates a “recipe” file for each device package and tray type. The image processor 70 is used for identifying and sorting and the devices present on the scanned JEDEC tray 30. The image generated by the line scan camera 10 is processed by the image processor 70 to decode two-dimensional matrix identification markings on the devices positioned in the JEDEC tray. Further, the image generated by the line scan camera 10 is processed with the recipe file. As shown in FIGS. 2 and 3, a recipe file contains an image of the scanned JEDEC tray 30 and information on the regions of interest (“ROI”) for the two dimensional locations on the JEDEC tray. For example, one region of interest may be empty pockets on the JEDEC tray 30. Another region of interest may be each orientation mark on the device packages positioned in the JEDEC tray 30. The binning handler 20 sorts and processes the devices according to the decoded two-dimensional matrix identification markings.

Due to programmable scanner software containing “recipes,” the line scan camera does not have to change to adapt to the type of device packages being processed. Recipes store specific information about a type of JEDEC tray and the devices that are positioned on the JEDEC tray in transport. For example, a recipe file will contain information for a specific JEDEC tray such as the distance between each row. Because the recipe file catalogues the physical characteristics of a JEDEC tray and its devices, the vision system can easily identify and locate regions of interest on the JEDEC tray. For example, as shown in FIG. 2, the highlighted region indicates the position of two dimension matrix identification marks 31. In FIG. 3, the highlighted region of interest is a orientation mark 32. Thus, because of the number of JEDEC tray configurations that may be stored as recipe files, one line scan camera 10 may be used for a variety of device packages that will vary in size and shape.

An image captured by the line scan camera 10 can also be processed by the image processor 70 to aid in the inspection of the devices positioned in the JEDEC tray. For example, the image processor 70 can determine whether a device on the JEDEC tray is positioned outside of its pocket. The image processor 70 can also determine the orientation of the devices positioned on the JEDEC tray 30. In addition, the image processor 70 can determine whether a device is present in certain pockets of a JEDEC tray 30. Further, an image generated by the line scan camera 10 can be used by the image processor 70 to identify a specific JEDEC tray 30 or inspect the JEDEC tray 30 for foreign material. Lastly, the images generated by a line scan camera 10 can be used by the image processor 70 to inspect the devices in the JEDEC tray and determine whether the devices have bent leads.

One advantage of the invention is that the line scan camera does not have to be changed or replaced to accommodate devices of different package sizes. Further, the line scan camera captures tray images while a transport mechanism transports the JEDEC tray into or out of the binning handler. Thus, the line scan camera of the present invention allows for full image capture without significantly affecting the amount of devices processed per hour by the handler. Further, the present invention is capable of automatically performing inspections that were previously part of an expensive back-end process.

The present invention can be used advantageously with semiconductor processing and handling equipment as described in commonly owned and co-pending provisional patent application entitled “Process for Handling Semiconductor Devices and Transport Media in Automated Sorting Equipment” Ser. No. 60/666,196, filed on Mar. 30, 2005, herein incorporated by reference in its entirety and commonly owned and co-pending provisional patent application entitled “LED Lighting System for Line Scan Camera Based Multiple Data Matrix Scanners” Ser. No. 60/666,307, filed on Mar. 30, 2005 herein incorporated by reference in its entirety.

Although the invention has been described in reference to a particular embodiment, various other embodiments and modifications will be apparent to those skilled in the art. It is therefore intended that the foregoing description of a preferred embodiment be considered as exemplary only.

What is claimed is:

1. A machine vision based scanner system for scanning semiconductor devices having an identification mark in an offline binning handler comprising:
a line scan camera capable of scanning a media tray holding the semiconductor devices and capturing a full tray-width image of the media tray;
a camera controller operatively connected to the line scan camera;
a tray transport mechanism positioned below the line scan camera;
a tray transport mechanism controller operatively connected to the tray transport mechanism and the camera controller; and
an image processor configured to execute image processing software for using the image captured by the line scan camera to identify and sort the semiconductor devices held in the media tray.

2. The machine vision based scanner system of claim 1, wherein the identification mark is a two dimensional matrix code provided on the surfaces of the semiconductor devices.

3. The machine vision based scanner system of claim 1, wherein the line scan camera is a 8 K pixel line scan camera having a depth of field of 4.0 mm.

4. The machine vision based scanner system of claim 1, wherein a depth of field of the line scan camera can be enhanced so that semiconductor devices of varying thickness positioned in the media tray can be inspected.

5. The machine vision based scanner system of claim 1, wherein the image processor generates a recipe file for each of the semiconductor devices and media tray scanned by the line scan camera, wherein the recipe file contains information regarding one or more regions of interest.

6. The machine vision based scanner system of claim 5, wherein the one or more regions of interest is an empty pocket in the media tray or an orientation mark positioned on each of the semiconductor devices.

7. The machine vision based scanner system of claim 1, wherein the tray transport mechanism is configured to carry a plurality of JEDEC trays in and out of the offline binning handler.

8. The machine vision based scanner system of claim 1, wherein the tray transport mechanism is configured to move the media tray at a constant velocity and the camera controller controls the line scan camera scanning speed to match the tray transport mechanism velocity.

9. The machine vision based scanner system of claim 1, wherein the image processor is configured to use the full tray-width image of the media tray to determine the orientation of the semiconductor devices in the media tray.

10. The machine vision based scanner system of claim 1, wherein the image processor is configured to use the full tray-width image of the media tray to determine whether one of the semiconductor devices is located out of a pocket of the media tray.

11. The machine vision based scanner system of claim 1, wherein the image processor is configured to use the full tray-width image of the media tray to determine whether one of the semiconductor devices is present in a pocket of the media tray.

12. The machine vision based scanner system of claim 1, wherein the image processor is configured to use the full tray-width image of the media tray to determine the type of media tray.

13. The machine vision based scanner system of claim 1, wherein the image processor is configured to use the full tray-width image of the media tray to determine whether foreign material is present on the media tray.

14. The machine vision based scanner system of claim 1, wherein the image processor is configured to use the full tray-width image of the media tray to determine whether any of the semiconductor devices held on the media tray have bent leads.
